(19) United States
(12) Patent Application Publication
(10) Pub. No.: US 2004/0008184 A1
(43) Pub. Date: Jan. 15, 2004

(54) Ergonomic electronic input device

(76) Inventor: P. Michael Leahy, Colorado Springs, CO (US)

Correspondence Address: PATTON BOGGS, PO BOX 270930, LOUISVILLE, CO, 80027, US

(21) Appl. No.: 10/191,084

(22) Filed: Jul. 9, 2002

(51) Int. Cl. G09G 5/08

(52) U.S. Cl. 345/157

(57) ABSTRACT

The ergonomic electronic input device ergonomically positions the hand of a user in a preferable ergonomic position during operation of the ergonomic electronic input device. The ergonomic electronic input device includes a vertically upright pedestal structure and flat base for use on a horizontal stationary surface to enable a user to control the operation of a computer to which it is connected. The ergonomic electronic input device includes a contoured vertical finger support member, palm support member, thumb support member and hand support member that supports the hand of a user during its operation. The ergonomic electronic input device includes a scrolling wheel located in the thumb support member and a laser light source device located in the flat base.

### FIELD OF THE INVENTION

This invention generally relates to a computer input device and more specifically concerns an ergonomic electronic input device having an improved ergonomic configuration that reduces or avoids stress problems traditionally associated with the long-term use of computer input devices. The improvement includes embodiments that may be reversed for alternate right or left handed use; may be easily retrofitted to an existing mouse as well as used for OEM embodiments; and may be custom fit to a user's hand.

### PROBLEM

The importance and usage of the computer mouse and trackball input devices have become nearly equivalent to that of the computer keyboard itself. With the popularity of electronic design tools, graphical user interfaces, and even computer games, at least one or both of these input devices have now become standard equipment assumed to be attached to every computer. Many software programs use movable cursors for selecting data and objects or drawing on a display monitor. The cursors are generally controlled by a manually manipulated pointing device connected to a computer. Common pointing devices include the mouse, trackball, touch pad, and digitizing tablet. A trackball serves the same function as a mouse, relative to the computer. The trackball is essentially a stationary device with a ball mounted for full rotational movement within the mounting base. A portion of the ball is exposed so that the ball may be rotated, as desired, within its mounting, by the thumb, fingers or part of the palm of the hand, for example.

The mouse is the most popular pointing device. It includes a housing that is slidably moved about on a flat, stationary surface. The housing contains a motion sensor on its bottom side for tracking its movement, one to three buttons on its front edge, and electronic circuitry for communicating with an attached computer. When the mouse is moved about, the cursor moves in corresponding directions; and when the buttons or switches are pressed, certain actions can be performed, depending on the software application using the mouse. The buttons or switches provide signals to the computer to perform one or another function, often related with the location or position of the cursor on the screen. Most computer mice currently carry one button or switch which provides a signal to the computer which is coordinated with the location of the cursor on the screen and a second button or switch which provides a signal to the computer which is independent of the cursor. The internal parts and electrical and software operations of computer mice are well known in the art. Most mice are substantially wider than they are tall, and have generally symmetrical sides so that they can be used by either the right or the left hand. Some mice are specially shaped for providing an optimal fit for a user's right hand.

Some mice include a surface for supporting some fingers in substantially curled positions. Some ergonomic mice are also made in left-handed versions. Many prior art mice have a generally horizontal, primary supporting surface for supporting a hand in a horizontal position. However, the most natural and relaxed position for a hand—when placed on a desk by a sifting person—is an upright position: the little finger side of the hand rests on the desk, and the fingers and palm generally define a vertical plane.

Some ergonomic prior art mice force the hand, wrist and forearm to be twisted closer to their natural and relaxed upright positions. For example, even the latest “ergonomic” designs demand a hand, wrist and arm position significantly inferior to the preferred neutral position (i.e., with the palm surface vertical). These designs also make the user susceptible to unnatural lateral, instead of flexing, wrist movements to control the cursor position.

Further, the user must constantly be grasping the mouse with at least two fingers when moving the cursor or even actuating the mouse buttons, adding further fatigue. In addition, many prior art designs tend to forget about the thumb, which is usually left to be dragged back and forth across the work surface or under the stress of constantly being held clear of the surface by the user. Actuating the mouse buttons causes additional stress since they are usually placed in such a way as to require the unnatural movement of the user's fingers in a direction away from the thumb. For a three-button mouse, the fore, middle and ring fingers must be kept in constant tension to prevent them from resting too heavily on the buttons and depressing them inadvertently. Note that many of these same design shortcomings also exist with the trackball devices presently available.

Thus, as the computer mouse and trackball devices continue to be heavily used in record numbers of homes and businesses, there is a great need to make a paradigm shift from the conventional mouse/trackball design and ergonomic mouse design to an input device design that is truly ergonomic, yet has all the control and functionality to which computer users have grown accustomed.

Some prior art ergonomic computer mouses are designed to be used by either a left or a right hand. By rotating a pedestal about a base, the buttons and controls are rotated so that the either hand can use them. However, with mouse designs such as these, a truly ergonomic fit for the operating hand cannot be achieved, because a truly ergonomic fit for one hand when rotated around a base will not ergonomically fit the other hand.

Further, some prior art ergonomic computer mouses are designed to support the hand in a substantially upright position, but the hand is forced to be rotated forward, thus not achieving a truly optimally-ergonomically shaped mouse.

Information relevant to attempts to address these problems can be found in U.S. Pat. Nos. D302,426 issued Jul. 25, 1989 to Bradley et al.; D328,597 issued Aug. 11, 1992 to Clouss; 4,862,165 issued Aug. 29, 1989 to Gart; 5,157,381 issued Oct. 20, 1992 to Cheng; 5,576,733 issued Nov. 19, 1996 to Lo; 5,648,798 issued Jul. 15, 1997 to Hamling; 5,894,303 issued Apr. 13, 1999 to Barr; and 6,262,715 issued Jul. 17, 2001 to Sawyer. However, each one of these references suffers from one or more of the following disadvantages: non-neutral hand position, less than optimal ergonomic hand position and poor thumb, finger and hand support.

### SOLUTION

The above-described problems are solved and a technical advance achieved by the present ergonomic electronic input device which comprises an optimally ergonomically-shaped pedestal which supports the thumb, finger and hand in an optimally ergonomically correct position and allows the hand to remain in a natural, untwisted and relaxed position. The mass of the ergonomic electronic input device is vertically oriented so that the hand, wrist and forearm of the user holding and operating the ergonomic electronic input device are maintained in a neutral disposition, without radial deviation or ulnar deviation, with the palm of the hand vertically disposed and the hand essentially resting on the ulnar portion thereof. Excursions of the novel ergonomic electronic input device across the work surface are effected by wrist flexion and extension without radial deviation or ulnar deviation and without forearm pronation or supination, but with neutrally oriented forearm and shoulder muscles.

The ergonomic electronic input device provides an electronic input device which minimizes or eliminates fatigue, discomfort and pain even after prolonged and continuous use. The ergonomic electronic input device provides a comfortable hand support at the base of the ergonomic electronic input device pedestal to comfortably support the weight of the hand, wrist and lower arm of the user to minimize or eliminate fatigue and discomfort even after prolonged use. It also includes a thumb-supporting surface for supporting the thumb, one or more buttons arranged on the upright finger-supporting surface, and a motion sensor on a bottom side.

In particular, the ergonomic electronic input device, functioning as either a mouse, trackball, or combination of both, allows the user to achieve a truly neutral operating position. The neutral positioning, preferred by occupational therapists, forms the basis of the numerous ergonomic advantages of the invention, such as elimination of unnatural lateral wrist movements. With the side of the hand comfortably resting on the support pad and thus the lower area of the ergonomic electronic input device, the user's hand is passively held by the present invention and may be moved across the work surface or operated in a stationary position by the trackball feature without the constant stress of holding the device.

A finger support member in the upper area of the ergonomic electronic input device supports and positions the fingers of users having a variety of hand sizes. The design and position of the upper housing also provides a place for the thumb to comfortably rest atop. Also, operation of the buttons and/or trackball requires only the natural flexing or squeezing motion of the fingers and thumb.

When configured as a mouse only, a rollerball or laser device communicates through an opening in the bottom surface of the lower housing to make contact with the work surface. The upper area typically contains three vertically aligned buttons to perform various mouse functions (e.g., selecting an item). A scrolling wheel is located where the thumb is positioned in the upper area to provide additional stress relieving functions, such as a cursor screen scrolling.

When configured as a combination mouse and trackball, the invention contains all of the aforementioned features along with a two-position toggle switch on the side of the lower housing. In the first position, mouse mode is -selected which-enables the bottom rollerball or laser sensors and disables the thumb trackball sensors. In the second position, trackball mode is selected which enables the thumb trackball sensors and disables the bottom rollerball or laser sensors.

The present novel ergonomic electronic input device includes at least two buttons or switches, which are located on or in the external surface of the mouse and positioned in the upper area of the mouse so that each switch is available for independent actuation by a respective finger of the hand.

The novel ergonomic electronic input device has an essentially flat top and an essentially flat bottom which rests on a substantially flat surface. This position orients the mass of the novel ergonomic electronic input device in vertical orientation. When viewed from the front of the ergonomic electronic input device or from the back of the ergonomic electronic input device, the external contour of the mass is asymmetrical, defining the smoothed-out mean or average of the contour of the inside (palm side) surface of the right hand and left hand, respectively, when the hand is in a relaxed, neutral state.

A right-handed version of the ergonomic electronic input device is designed to be used with the right hand of a user and a left-handed version of the ergonomic electronic input device is designed to be used with the left hand of a user. The external contour of the right and left sides of the ergonomic electronic input device are molded to the optimally-ergonomically contour of the inside surface of the right or left hand respectively, and when the hand is in a relaxed, neutral condition, such as a cupped condition, provides an ergonomic electronic input device which may be held and operated while maintaining the operating hand and wrist in the radial-ulnar deviation plane, and the forearm in a neutral state, while the thumb is supported atop the ergonomic electronic input device, reducing substantially the operating effort of the user of the ergonomic electronic input device.

Input devices with a vertical hand and wrist attitude are known and used in connection with computer games and take the form of gun-like grips (and joystick devices); however, these devices do not include the ergonomic electronic input device features such as a control means in the base which moves a computer cursor in a direction or distance proportional to the movement of the base. Rather, these non-mouse input means have different structures functioning in a different manner to produce a different result.

### BRIEF DESCRIPTION OF THE DRAWINGS

The above and other features of the present invention can be better understood from a reading of the detailed description and the following drawings:

FIG. 1 illustrates a front perspective view of the ergonomic electronic input device including a scrolling wheel embodiment;

FIG. 2 illustrates a back perspective view of the ergonomic electronic input device including a scrolling wheel embodiment;

FIG. 3 illustrates a left side view of the ergonomic electronic input device including a scrolling wheel embodiment;

FIG. 4 illustrates a right side view of the ergonomic electronic input device including a scrolling wheel embodiment;

FIG. 5 illustrates a front view of the ergonomic electronic input device;

FIG. 6 illustrates a back view of the ergonomic electronic input device;

FIG. 7 illustrates a top view of the ergonomic electronic input device including a scrolling wheel embodiment;

FIG. 8 illustrates a front perspective view of the ergonomic electronic input device including a trackball embodiment;

FIG. 9 illustrates a back perspective view of the ergonomic electronic input device including a trackball embodiment;

FIG. 10 illustrates a left side view of the ergonomic electronic input device including a trackball embodiment;

FIG. 11 illustrates a right side view of the ergonomic electronic input device including a trackball embodiment;

FIG. 12 illustrates a front view of the ergonomic electronic input device including a trackball embodiment;

FIG. 13 illustrates a back view of the ergonomic electronic input device including a trackball embodiment;

FIG. 14 illustrates a top view of the ergonomic electronic input device including a trackball embodiment;

FIG. 15 illustrates a bottom view of the ergonomic electronic input device including a rollerball device;

FIG. 16 illustrates a bottom view of the ergonomic electronic input device including a hole for a laser light source;

FIG. 17 illustrates an adjustable height support pad;

FIGS. 18A-18C illustrate cross-sections of differing thickness of the adjustable height support pads of FIG. 17 through 18-18;

FIG. 19 illustrates a front perspective view of a left-handed embodiment of the ergonomic electronic input device; and

FIG. 20 illustrates a back perspective view of a left-handed embodiment of the ergonomic electronic input device.

### DETAILED DESCRIPTION

The ergonomic electronic input device is a vertical upright electronic input apparatus that is attached to a stable base. The hypothenar area of a user's hand rests on the flat base of the ergonomic electronic input device, with the hand in a substantially vertical position.

Layout of the Ergonomic Electronic Input Device

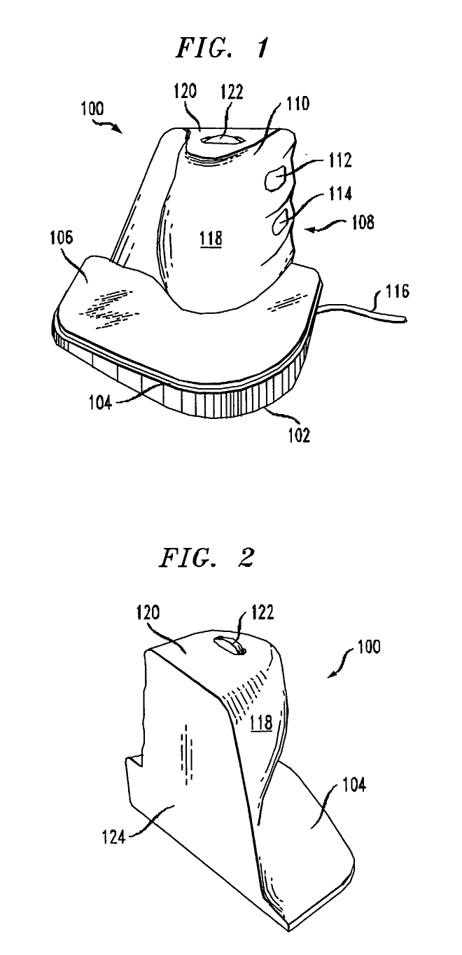

FIG. 1 illustrates the flat base 102 of the ergonomic electronic input device 100 and is substantially flat and the bottom of the flat base 102 is oriented generally horizontal so that it contacts a substantially horizontal stationary surface, including desktops, mouse pads, books, laps and floors. Translation of the ergonomic electronic input device 100 includes moving the ergonomic electronic input device 100 from one location to another.

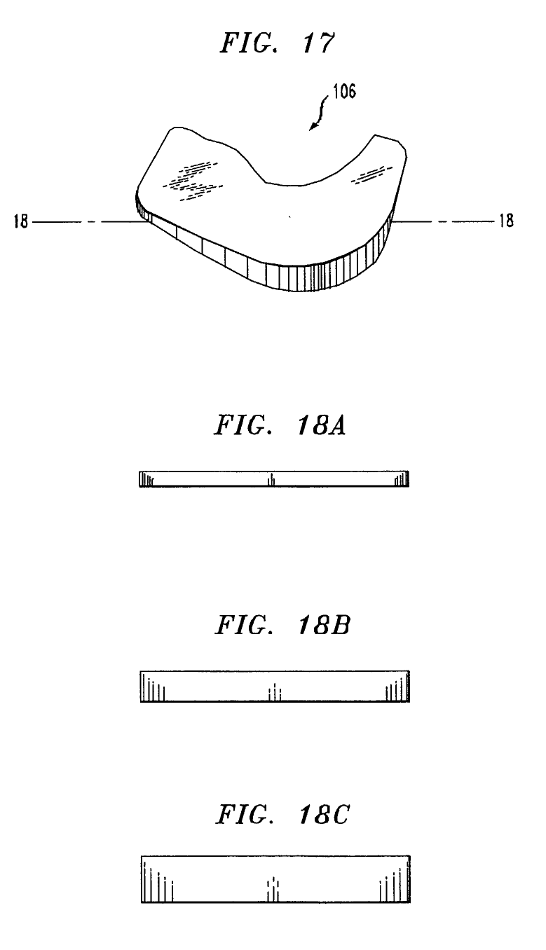

The hand support member 104 is located on the topside of the flat base 102 and is formed to accept adjustable height support pads 106. The hand support member 104 is formed to support the hypothenar area controlling the ergonomic electronic input device 100. The hand support member 104 is made of a plastic or, alternatively, other materials such as polyvinyl chloride, polyethylene and urea-formaldehyde. The adjustable height support pads 106 comprise a rubber or, alternatively, other elastic materials such as plastic, polymers, or any other material having an elastic or semi-elastic property. The adjustable height support pads 106 can be of differing heights, as shown in FIGS. 18A-18C. The adjustable heights of the adjustable height support pads 106 are utilized by a user to elevate the hypothenar area to engage the fingers of a user's hand with a finger support member 108. One or more adjustable height support pads 106 can be used at one time to accomplish this function. Conversely, for larger hands, the hypothenar area of a user can be placed directly on the hand support member 104 without using any of the adjustable height support pads 106.

The ergonomic electronic input device 100 further includes a vertically upright pedestal structure 110 that is attached with the flat base 102. The vertically upright pedestal structure 110 is formed to fit the contours of a user's palm area of the user's hand. The vertically upright pedestal structure 110 is asymmetrical with respect to its shape. The vertically upright pedestal structure 110 is made of a plastic or, alternatively, other materials such as polyvinyl chloride, polyethylene and urea-formaldehyde. In a preferred embodiment of the present invention, the vertically upright pedestal structure 110 is formed to fit the right hand of a user. In another embodiment of the present invention, the vertically upright pedestal structure 110 is formed to fit the left hand of a user.

The finger support member 108 is integral to the vertically upright pedestal structure 110. The contours of the finger support member 108 are formed to fit the index finger, middle finger, ring finger and the little finger of a user's hand in a vertical relaxed cupped position. The finger support member 108 is formed to contour to each individual finger of a user's hand as they are placed around finger support member 108 in a relaxed vertical cupped position. The finger support member 108 has an individual contour area for each of the aforementioned fingers. In a preferred embodiment of the present invention, the finger support member 108 is formed to fit the fingers of the right hand of a user. In another embodiment of the present invention, the finger support member 108 is formed to fit the fingers of the left hand of a user. The finger support member 108 is made of a plastic or, alternatively, other materials such as polyvinyl chloride, polyethylene and urea-formaldehyde.

The finger support member 108 has at least one substantially vertical computer control button 112 pivotally attached to the finger support member 108. A finger of the user-depresses the computer control button 112 which generates electrical signals that are sent to a computing device via connection 116 and are then followed by a command of a cursor on a display screen of the computing device. In a preferred embodiment, the ergonomic electronic input device 100 has two computer control buttons 112 and 114 located adjacent to each other. These two computer control buttons 112 and 114 are located so as to engage the index finger and middle finger of a user, respectively. Alternatively, the ergonomic electronic input device 100 can have more than two computer control buttons.

The palm support member 118 is integral to the vertically upright pedestal structure 110 for supporting and positioning the palm of a user's upright positioned hand. The palm support member 118 is formed to contour to a user's palm as it is placed around the palm support member 118. In a preferred embodiment of the present invention, the palm support member 118 is formed to fit the palm area of the right hand of a user. In another embodiment of the present invention, the palm support member 118 is formed to fit the palm area of the left hand of a user. The palm support member 118 is made of a plastic or, alternatively, other materials such as polyvinyl chloride, polyethylene and urea-formaldehyde.

The thumb support member 120 is located on top of the vertically upright pedestal structure 110. The thumb support member 120 is for supporting the thumb of a user's hand. The thumb support member 120 is substantially horizontal and includes a first positional device. In the preferred embodiment of the present invention, the first positional device is a scrolling wheel 122. The scrolling wheel 122 protrudes from the top of the thumb support member 120. In a preferred embodiment of the present invention, the thumb support member 120 is formed to fit the thumb of the right hand of a user. In another embodiment of the present invention, the thumb support member 120 is formed to fit the thumb of the left hand of a user. The scrolling wheel 122 accepts input from a user's thumb or other fingers and translates this movement into electrical signals for a computer or, alternatively, other electronic devices such as personal digital assistants (PDA's), laptop computers, microcomputers, minicomputers or personal computers. The thumb support member 120 is made of a plastic or, alternatively, other materials such as polyvinyl chloride, polyethylene and urea-formaldehyde.

FIG. 8 depicts another embodiment of the first positional device. This embodiment is a trackball device 134. The trackball device 134 is a device that has a rotatable ball that is partially exposed outside of a housing to enable a user to rotate the ball with a thumb or finger. The rotation of the ball produces electronic signals that are sent to a computing device via connection 116 and are then followed by movement of a cursor on a display screen of the computing device. The trackball ball 134 is partially inset into the thumb support member 120 to engage the thumb of a user of the ergonomic electronic input device 100.

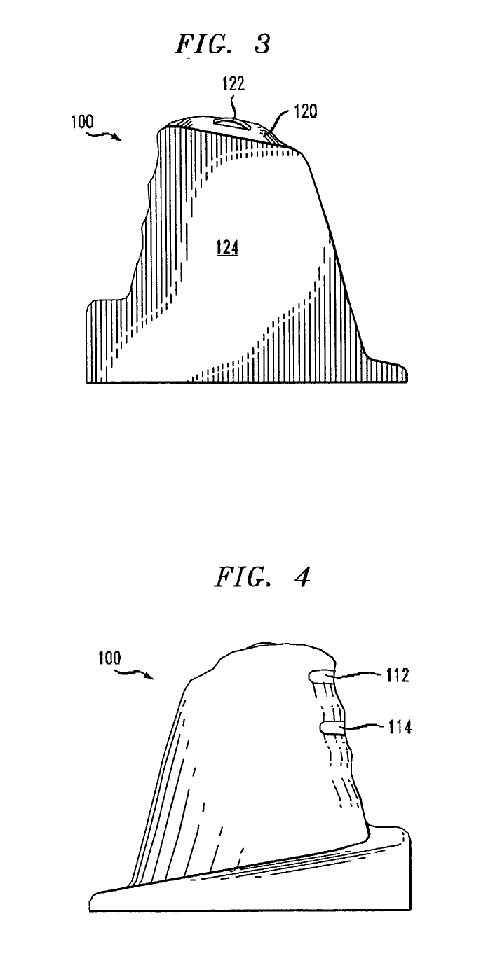

FIG. 2 is a back perspective view of the ergonomic electronic input device 100. The adjustable height support pad 106 is not in place in this perspective. This view shows the aft area of the hand support member 104. The left side 124 of the ergonomic electronic input device 100 is shown and is substantially vertical and planar. FIG. 3 is a view of the left side 124 of the ergonomic electronic input device 100. FIG. 4 is a view of the right side of the ergonomic electronic input device 100. In a preferred embodiment of the present invention, the left side 124 of the ergonomic electronic input device 100 is substantially planar and the right side of the vertically upright pedestal structure 110 is formed to fit the right hand of a user. In another embodiment of the present invention, the right side of the ergonomic electronic input device 100 is substantially planar and the left side is formed to fit the left hand of a user.

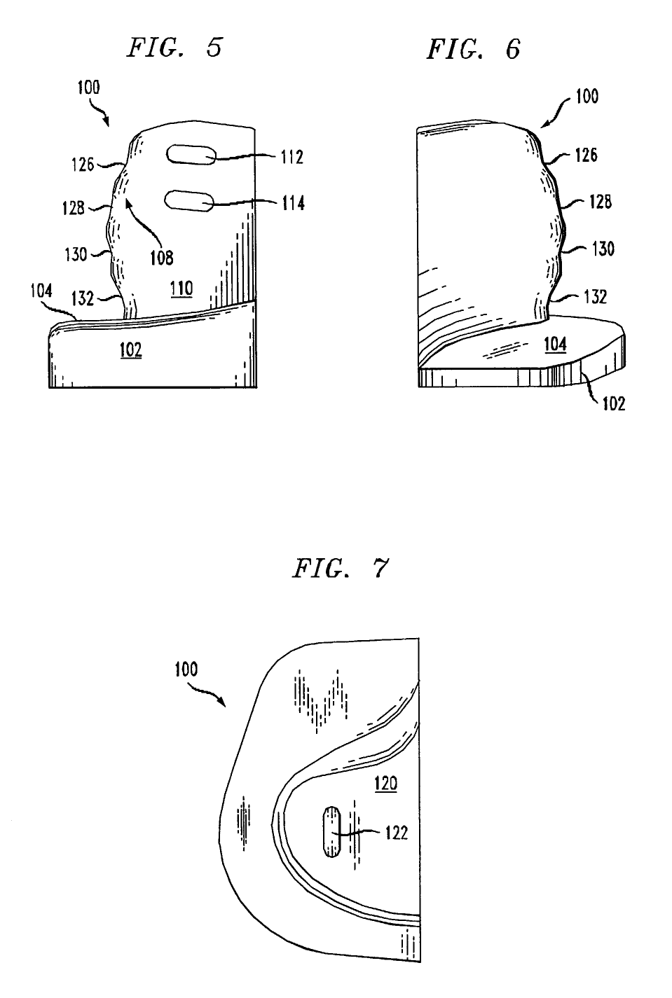

FIG. 5 illustrates the front view of the ergonomic electronic input device 100. The vertically upright pedestal structure 110 includes contour 126 which is formed to support the index finger, contour 128 is formed to support the middle finger, contour 130 is formed to support the ring finger and contour 132 is formed to support the little finger of a user's hand. A user's fingers fit comfortably within these contours to assist in supporting the weight of the hand and to orient the finger ends with the computer control buttons 112 and 114. FIG. 6 illustrates the aft area of contours 126,128, 130 and 132.

FIG. 7 illustrates the top view of the preferred embodiment of the ergonomic electronic input device 100. The scrolling wheel 122 is shown located in the thumb support member 120.

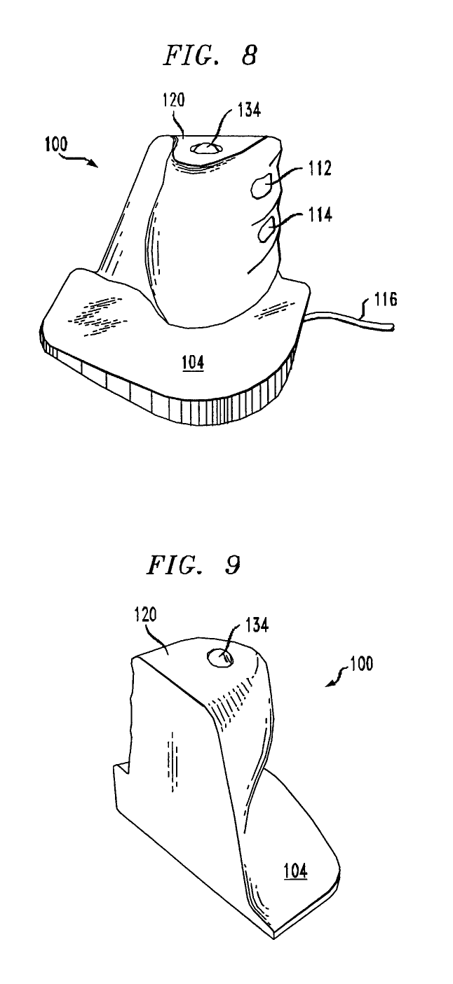

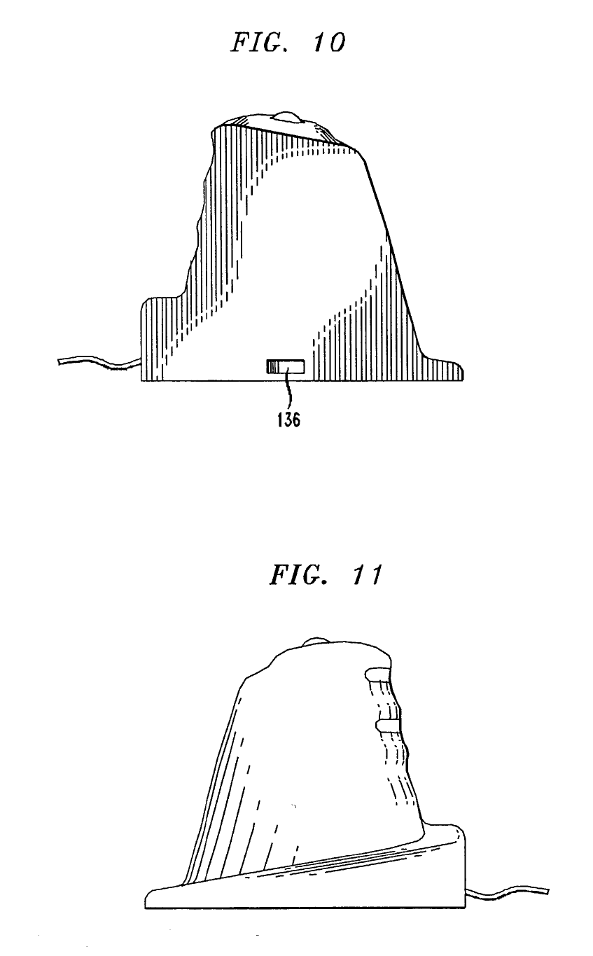

FIG. 8 illustrates the front perspective view of another embodiment of the ergonomic electronic input device 100. In this embodiment, a trackball 134 is shown protruding out of the top of the thumb support member 120. Also in this embodiment, the adjustable height support pads 106 are not shown. FIG. 9 illustrates the back perspective view of the trackball embodiment of the present invention. FIG. 10 illustrates the left side of the ergonomic electronic input device 100 including the trackball embodiment. In the preferred embodiment of the present invention, a switch 136 is located on the left side of the ergonomic electronic input device 100. Switch 136 is used to change the ergonomic electronic input device 100 from a conventional design with the rollerball on the bottom of the ergonomic electronic input device to a trackball design and vice versa. Switch 136 is located in the flat base 102 that controls the enablement between the trackball embodiment and the rollerball embodiment. When the switch 136 is in a first position, the trackball 134 is enabled and the rollerball 140 is disabled. When the switch 136 is in a second position, the rollerball 140 is enabled and the trackball 134 is disabled. When the trackball 134 is enabled, the ergonomic electronic input device 100 can be kept stationary with regard to the horizontal stationary surface, while the user rotates the trackball ball 134 to communicate the user's desired cursor locations to a computing device. Conversely, when the rollerball 140 is enabled, the ergonomic electronic input device 100 is moved by the user relative to the horizontal stationary surface to communicate the user's desired cursor locations to a computing device.

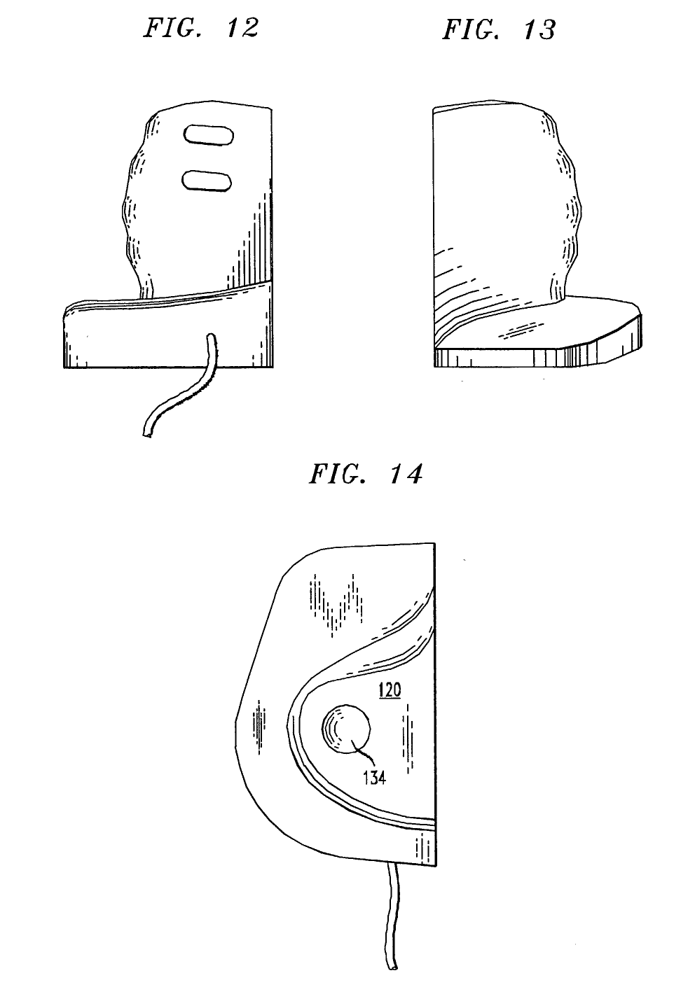

FIG. 11 illustrates the right side of the ergonomic electronic input device 100 including the trackball embodiment. In a preferred embodiment of the present invention, the left side of the ergonomic electronic input device 100 includes the switch 136 and the right side of the vertically upright pedestal structure 110 is formed to fit the right hand of a user. In another embodiment of the present invention, the right side of the ergonomic electronic input device 100 includes the switch 136 and the left side is formed to fit the left hand of a user. FIG. 12 illustrates the front view of the trackball embodiment of the ergonomic electronic input device 100. FIG. 13 illustrates the back view of the trackball embodiment of the ergonomic electronic input device 100. FIG. 14 illustrates a top view of the trackball located in the thumb support member 120.

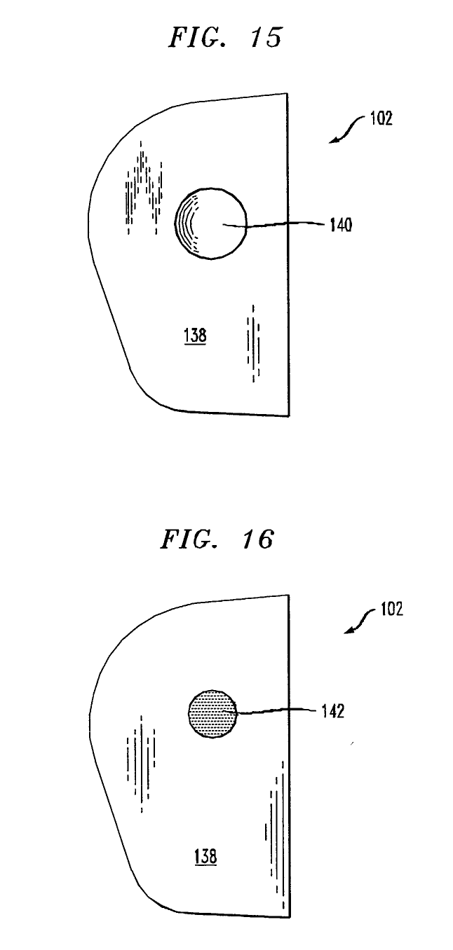

In FIGS. 15 and 16, a second positional device is located on the bottom side 138 of the flat base 102. In a preferred embodiment, a laser light source 142 determines the translational movement of the ergonomic electronic input device 100. In this embodiment, the ergonomic electronic input device 100 communicates the translational movement of the ergonomic electronic input device 100 relative to the horizontal stationary surface to a computing device via a laser light source 142.

In another embodiment, the second positional device comprises a rollerball 140 that is vertically displaceably mounted with the flat base 138 for rotatably contacting a horizontal stationary surface. The rollerball 140 is rotatable and partially positioned within the flat base 100 and protrudes from the bottom of the flat base 100 to contact the horizontal stationary surface. In this embodiment, movement of the ergonomic electronic input device 100 rotates the rollerball which generates electrical signals that are sent to a computing device via connection 116 and are then followed by the movement of a cursor on a display screen of the computing device.

FIG. 17 is an illustration of the adjustable height support pads 106. The adjustable height support pads 106 are removable from the hand support member 104. The adjustable height support pads 106 have varying thickness as shown in FIGS. 18A-18C, which are cross-section views of FIG. 17. For example, FIG. 18A illustrates an adjustable height support pad 106 having a thickness of 3 mm. In another example, FIG. 18B illustrates an adjustable height support pad 106 having a thickness of 5 mm. In another example, FIG. 18C illustrates an adjustable height support pad 106 having a thickness of 8 mm.

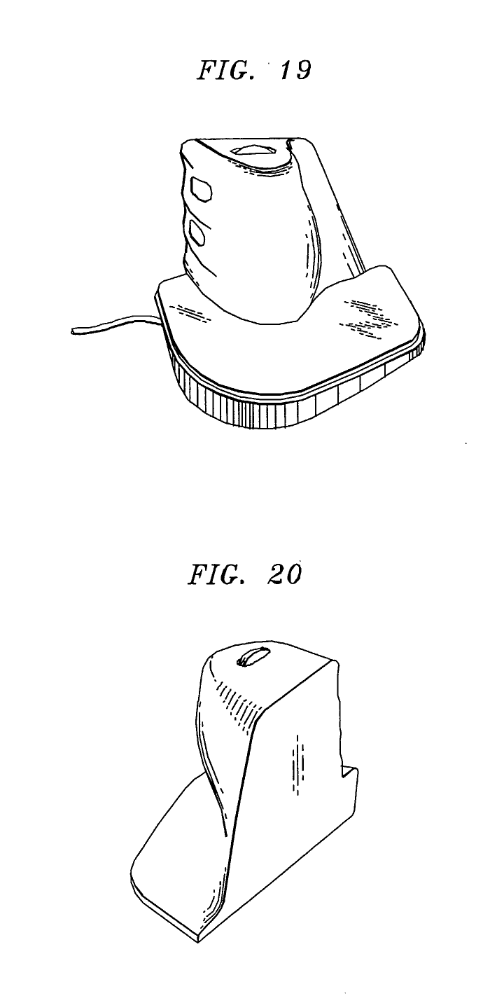

FIGS. 19 and 20 illustrate a front perspective view of a left-handed embodiment of the ergonomic electronic input device 100. All features described in FIGS. 1-16 are incorporated in FIGS. 19 and 20. FIGS. 19 and 20 illustrate the mirror image of the ergonomic electronic input device 100 as described in FIGS. 1-16.

### EXAMPLE 1

Right-Handed Rollerball and Scrolling Wheel Embodiment

In this example, as illustrated in FIGS. 1, 2 and 15, a flat base 102 is located on a substantially horizontal surface. A hand support member 104 is located on top of the flat base 102. A vertically upright pedestal structure 110, formed to ergonomically fit the right hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A rollerball 140 is located protruding from the bottom of the flat base 102. A scrolling wheel 122 is located on the thumb support member 120. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the right hand of a user, and computer control button 114 is located on the finger support member 108 to enable the engagement with the end of the middle finger of the right hand of a user.

### EXAMPLE 2

Left-Handed Rollerball and Scrolling Wheel Embodiment

In this example, as illustrated in FIGS. 15, 19 and 20, a flat base 102 is located on a substantially horizontal surface. A hand support member 104 is located on top of the flat base 102. A vertically upright pedestal structure 110, formed to ergonomically fit the left hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A rollerball 140 is located protruding from the bottom of the flat base 102. A scrolling wheel 122 is located on the thumb support member 120. A 3mm adjustable height support pad 106 is located on top of the hand support member 104. Two computer control buttons 112 and 114 are located vertically on the finger support member 108. Computer control button 112 is located on the finger support member 108-to-enable the engagement with the end of the index finger of the left hand of a user, and computer control button 114 is located on the finger support member 108 to enable the engagement with the end of the middle finger of the left hand of a user.

### EXAMPLE 3

Right-Handed Laser Light Source and Scrolling Wheel Embodiment

In this example, as illustrated in FIGS. 1, 2 and 16, a flat base 102 is located on a substantially horizontal surface. A hand support member 104 is located on top of the flat base 102. A vertically upright pedestal structure 110, formed to ergonomically fit the right hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A laser light source 142 is located protruding from the bottom of the flat base 102. A scrolling wheel 122 is located on the thumb support member 120. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the right hand of a user, and computer control button 114 is located on the finger support member 108 to enable the engagement with the end of the middle finger of the right hand of a user.

### EXAMPLE 4

Left-Handed Laser Light Source and Scrolling Wheel Embodiment

In this example, as illustrated in FIGS. 16, 19 and 20, a flat base 102 is located on a substantially horizontal surface. In this example, FIGS. 19 and 20 are the left hand embodiment of FIGS. 1 and 2 and include all of the features described in FIGS. 1 and 2 respectively in a left-handed embodiment of the invention. A hand support member 104 is located on top of the flat base 102. A vertically upright pedestal structure 110, formed to ergonomically fit the left hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A laser light source 142 is located protruding from the bottom of the flat base 102. A scrolling wheel 122 is located on the thumb support member 120. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the left hand of a user, and computer control button 114 is located on the finger support member 108 to enable the engagement with the end of the middle finger of the left hand of a user.

### EXAMPLE 5

Right-Handed Trackball Embodiment

In this example, as illustrated in FIGS. 8 and 9, a flat base 102 is located on a substantially horizontal surface. A hand support member 104 is located on top of the flat base 102. A vertically upright pedestal structure 110, formed to ergonomically fit the right hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the right hand of a user, and computer control button 114 is located on the finger support member 108 to enable the engagement with the end of the middle finger of the right hand of a user.

### EXAMPLE 6

Left-Handed Trackball Embodiment

In this example, as illustrated in FIGS. 19 and 20, a flat base 102 is located on a substantially horizontal surface. A hand support member 104 is located on top of the flat base 102. In this example, FIGS. 19 and 20 are the left hand embodiment of FIGS. 8 and 9 and include all of the features described in FIGS. 8 and 9 respectively in a left-handed embodiment of the invention. A vertically upright pedestal structure 110, formed to ergonomically fit the left hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the left hand of a user, and computer control button 114 is located on the finger support member 108 to enable the engagement with the end of the middle finger of the left hand of a user.

### EXAMPLE 7

Right-Handed Rollerball and Trackball Combination Embodiment In this example, as illustrated in FIGS. 10, 11 and 15, a flat base 102 is located on a substantially horizontal surface. A hand support member 104 is located on top of the flat base 102. A vertically upright pedestal structure 110, formed to ergonomically fit the right hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A rollerball 140 is located protruding from the bottom of the flat base 102. A switch 136 is located on the left side of the flat base 102 and when switched in a first position, the trackball device 134 is enabled and the rollerball 140 is disabled. When the switch 136 is switched in a second position, the rollerball 140 is enabled and the trackball device 134 is disabled. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the right hand of a user, and computer control button 114 is located on the finger support member 108 to enable the engagement with the end of the middle finger of the right hand of a user.

### EXAMPLE 8

Left-Handed Rollerball and Trackball Combination Embodiment

In this example, as illustrated in FIGS. 15, 19 and 20, a flat base 102 is located on a substantially horizontal surface. In this example, FIGS. 19 and 20 are the left hand embodiment of FIGS. 10 and 11 and include all of the features described in FIGS. 10 and 11 respectively in a left-handed embodiment of the invention. A hand support member 104 is located on top of the flat base 102. A vertically upright pedestal structure 110, formed to ergonomically fit the left hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A rollerball 140 is located protruding from the bottom of the flat base 102. A switch 136 is located on the right side of the flat base 102 and when switched in a first position, the trackball device 134 is enabled and the rollerball 140 is disabled. When the switch 136 is switched in a second position, the rollerball 140 is enabled and the trackball device 134 is disabled. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the left hand of a user, and computer control button 114 is located on the finger support member 108 to enable the engagement with the end of the middle finger of the left hand of a user.

### EXAMPLE 9

Right-Handed Laser Light Source and Trackball Combination Embodiment

In this example, as illustrated in FIGS. 10, 11 and 16, a flat base 102 is located on a substantially horizontal surface. A hand support member 104 is located on top of the flat base 102. A vertically upright pedestal structure 110, formed to ergonomically fit the right hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A laser light source 142 is located on the bottom of the flat base 102. A switch 136 is located on the left side of the flat base 102 and when switched in a first position, the trackball device 134 is enabled and the laser light source 142 is disabled. When the switch 136 is switched in a second position, the laser light source 142 is enabled and the trackball device 134 is disabled. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the right hand of a user, and computer control button 114 is located on the finger support member 108 to enable the engagement with the end of the middle finger of the right hand of a user.

### EXAMPLE 10

Left-Handed Laser Light Source and Trackball Combination Embodiment

In this example, as illustrated in FIGS. 16, 19 and 20, a flat base 102 is located on a substantially horizontal surface. In this example, FIGS. 19 and 20 are the left hand embodiment of FIGS. 10 and 11 and include all of the features described in FIGS. 10 and 11 respectively in a left-handed embodiment of the invention. A hand support member 104 is located on top of the flat base 102. A vertically upright pedestal structure 110, formed to ergonomically fit the left hand of a user, is located on top of the flat base 102. Located on top of the vertically upright pedestal structure 110 is a thumb support member 120. A connection 116 is located at the flat base 102 of the ergonomic electronic input device and is connected to a computing device (not shown). A trackball device 134 is located on the thumb support member 120. A laser light source 142 is located on the bottom of the flat base 102. A switch 136 is located on the left side of the flat base 102 and when switched in a first position, the trackball device 134 is enabled and the laser light source 142 is disabled. When the switch 136 is switched in a second position, the laser light source 142 is enabled and the trackball device 134 is disabled. A 3 mm adjustable height support pad 106 is located on top of the hand support member 104. Two computer control buttons 112 and 114 are located vertically on the finger support member 108. Computer control button 112 is located on the finger support member 108 to enable the engagement with the end of the index finger of the left hand of a user, and computer control button 114 is located on the finger support member 108 to enable the engagement with the end of the middle finger of the left hand of a user.

### SUMMARY

The ergonomic electronic input device ergonomically positions the hand of a user in a most preferable ergonomic position during operation of the ergonomic electronic input device. The ergonomic electronic input device includes a flat base for translation over a substantially horizontal surface and a vertically upright pedestal structure. The ergonomic electronic input device includes a contoured vertical finger support member, palm support member, thumb support member and hand support member that supports the hand of a user during its operation in a relaxed vertical cupped position. In a preferred embodiment, the ergonomic electronic input device includes a scrolling wheel located on the thumb support member and a laser light source device located in the flat base.

Although there has been described what is at present considered to be the preferred embodiments of the present invention, it will be understood that the invention can be embodied in other specific forms without departing from the spirit or essential characteristics thereof. The present embodiments are, therefore, to be considered in all aspects as illustrative and not restrictive. The scope of the invention is indicated by the appended claims rather than the foregoing description.

What is claimed:

1. An ergonomic electronic input device for use on a horizontal stationary surface to enable a user to control the operation of a computer to which it is connected, comprising:
a substantially flat base;
a hand support member located on top of said flat base for supporting the hypothenar area of an upright positioned hand;
a vertically upright pedestal structure attached to said flat base;
a palm support member integral to said vertically upright pedestal structure for supporting and positioning the palm of said upright positioned hand adjacent to said vertically upright pedestal structure in a vertical neutral position;
a finger support member integral to said vertically upright pedestal structure for supporting and positioning the fingers of said upright positioned hand adjacent to said vertically upright pedestal structure in a vertically neutral cupped position, said finger support member comprising horizontally-contoured areas corresponding to said fingers of said upright positioned hand;
a thumb support member located on top of said vertically upright pedestal structure for supporting the thumb of said upright positioned hand in a neutral cupped position, wherein said thumb support member is substantially horizontal;
a first positional device rotatably protruding upwardly through said thumb support member, wherein said first positional device accepts movement by a user and translates said movement into electrical signals;
a second positional device located in said flat base, wherein said second positional device translates translational movement of said ergonomic electronic input device relative to said horizontal stationary structure-into electrical signals; and
at least one substantially vertical computer control button pivotally attached to said finger support member for enabling engagement with said fingers of said upright positioned hand to generate electrical signals.

2. The ergonomic electronic input device for use on a horizontal stationary surface to enable a user to control the operation of a computer to which it is connected of claim 1, further comprising a switch for selectively activating said first positional device and said second positional device.

3. The ergonomic electronic input device for use on a horizontal stationary surface to enable a user to control the operation of a computer to which it is connected of claim 1 wherein said first positional device comprises a scrolling wheel.

4. The ergonomic electronic input device for use on a horizontal stationary surface to enable a user to control the operation of a computer to which it is connected of claim 1 wherein said first positional device comprises a trackball.

5. The ergonomic electronic input device for use on a horizontal stationary surface to enable a user to control the operation of a computer to which it is connected of claim 1 wherein said second positional device comprises a rollerball vertically displaceably mounted with said flat base for rotatably contacting said horizontal stationary surface.

6. The ergonomic electronic input apparatus for use on a horizontal stationary surface to enable a user to control the operation of a computer to which it is connected of claim 1 wherein said second positional device comprises a laser device for contacting said horizontal stationary surface.

7. The ergonomic electronic input device for use on a horizontal stationary surface to enable a user to control the operation of a computer to which it is connected of claim 1 wherein said hand support member further comprises height support pads of varying thickness.

8. The ergonomic electronic input device for use on a horizontal stationary surface to enable a user to control the operation of a computer to which it is connected of claim 7 wherein the thickness of said hand support members is 3 mm-10 mm.

9. An ergonomic electronic input device for use on a horizontal stationary surface to enable a user to control the operation of a computer to which it is connected, comprising:
a substantially flat base;
a hand support member located on top of said flat base for supporting the hypothenar area of an upright positioned hand;
a vertically upright pedestal structure attached to said flat base;
a palm support member integral to said vertically upright pedestal structure for supporting and positioning the palm of said upright positioned hand adjacent to said vertically upright pedestal structure in a vertical neutral position;
a finger support member integral to said vertically upright pedestal structure for supporting and positioning the fingers of said upright positioned hand adjacent to said vertically upright pedestal structure in a vertically neutral cupped position, said finger support member comprising horizontally-contoured areas corresponding to said fingers of said upright positioned hand;
a thumb support member located on top of said vertically upright pedestal structure for supporting the thumb of said upright positioned hand in a neutral cupped position, wherein said thumb support member is substantially horizontal;
a first means for inputting attached to said thumb support member, wherein said first inputting means accepts movement by a user and translates said movement into electrical signals;
a second means for inputting attached to said flat base, wherein said second inputting means translates translational movement of said ergonomic electronic input device relative to said horizontal stationary structure into electrical signals; and
a means for sensing attached to said finger support member, wherein said sensing means is disposed to enable engagement with said fingers of said upright positioned hand to generate electrical signals.

10. The ergonomic electronic input device for use on a horizontal stationary surface to enable a user to control the operation of a computer to which it is connected of claim 9, further comprising a switch for selectively activating said first positional device and said second positional device.

11. The ergonomic electronic input device for use on a horizontal stationary surface to enable a user to control the operation of a computer to which it is connected of claim 9 wherein said hand support member further comprises height support pads of varying thickness.

12. The ergonomic electronic input device for use on a horizontal stationary surface to enable a user to control the operation of a computer to which it is connected of claim 11 wherein the thickness of said hand support members is 3 mm-10 mm.

13. An ergonomic electronic input device for use on a horizontal stationary surface to enable a user to control the operation of a computer to which it is connected, comprising:
a substantially flat base;
a hand support member located on top of said base for supporting the hypothenar area of an upright positioned hand;
a vertically upright pedestal structure attached to said flat base;
a palm support member integral to said vertically upright pedestal structure for supporting and positioning the palm adjacent to said vertically upright pedestal structure in a vertical neutral position;
a finger support member integral to said vertically upright pedestal structure for supporting and positioning a plurality of fingers adjacent to said vertically upright pedestal structure in a vertically neutral cupped position, said finger support member comprising horizontally-contoured areas corresponding to said plurality of fingers;
a thumb support member located on top said vertically upright pedestal structure for supporting the thumb of an upright positioned hand in a neutral cupped position, wherein said thumb support member is substantially perpendicular to said vertically upright pedestal structure;
a scrolling wheel device protruding upwardly through said thumb support member, wherein said scrolling wheel device accepts movement by a finger or thumb of a user and translates movement of said first positional device into electrical signals for processing by a computer;
a laser light source located in said flat base, wherein said laser light source translates translational movement of said ergonomic electronic input device relative to said horizontal stationary structure into electrical signals for processing by a computer;
a first substantially vertical computer control button pivotally attached to said finger support member for enabling engagement with a forefinger of said upright positioned hand; and
a second substantially vertical computer control button pivotally attached to said finger support member for enabling engagement with a middle finger of said upright positioned hand.

14. The ergonomic electronic input device for use on a horizontal stationary surface to enable a user to control the operation of a computer to which it is connected of claim 13 wherein said hand support member further comprises height support pads of varying thickness.

15. The ergonomic electronic input device for use on a horizontal stationary surface to enable a user to control the operation of a computer to which it is connected of claim 14 wherein the thickness of said hand support members is 3 mm-10 mm.

16. An ergonomic electronic device for use on a horizontal stationary surface to enable a user to control the operation of a computer to which it is connected, comprising:
a substantially flat base;
a hand support member located on top of said base for supporting the hypothenar area of an upright positioned hand;
a vertically upright pedestal structure attached to said flat base;
a palm support member integral to said vertically upright pedestal structure for supporting and positioning the palm adjacent to said vertically upright pedestal structure in a vertical neutral position;
a finger support member integral to said vertically upright pedestal structure for supporting and positioning a plurality of fingers adjacent to said vertically upright pedestal structure in a vertically neutral cupped position, said finger support member comprising horizontally-contoured areas corresponding to said plurality of fingers;
a thumb support member located on top said vertically upright pedestal structure for supporting the thumb of said upright positioned hand in a neutral cupped position, wherein said thumb support member is substantially perpendicular to said vertically upright pedestal structure;
a scrolling wheel device protruding upwardly through said thumb support member, wherein said scrolling wheel device accepts movement by a finger or thumb of a user and translates movement of said first positional device into electrical signals for processing by a computer;
a rollerball device located in said flat base, wherein said rollerball device translates translational movement of said ergonomic electronic input device relative to said horizontal stationary structure into electrical signals for processing by a computer;
a first substantially vertical computer control button pivotally attached to said finger support member for enabling engagement with a forefinger of said upright positioned hand; and
a second substantially vertical computer control button pivotally attached to said finger support member for enabling engagement with a middle finger of said upright positioned hand.

17. The ergonomic electronic input device for use on a horizontal stationary surface to enable a user to control the operation of a computer to which it is connected of claim 16 wherein said hand support member further comprises height support pads of varying thickness.

18. The ergonomic electronic input device for use on a horizontal stationary surface to enable a user to control the operation of a computer to which it is connected of claim 17 wherein the thickness of said hand support members is 3 mm-10 mm.
